(19) United States
(12) Patent Application Publication
(10) Pub. No.: US 2009/0160975 A1
(43) Pub. Date: Jun. 25, 2009

(54) Methods and Apparatus for Improved Image Processing to Provide Retroactive Image Focusing and Improved Depth of Field in Retail Imaging Systems

(75) Inventor: Sik Piu Kwan, Suwanee, GA (US)

Correspondence Address: PAUL W. MARTIN, NCR CORPORATION, LAW DEPT., 1700 S. PATTERSON BLVD., DAYTON, OH, 45479-0001, US

(73) Assignee: NCR Corporation, Dayton, OH (US)

(21) Appl. No.: 11/959,856

(22) Filed: Dec. 19, 2007

(51) Int. Cl. H04N 5/76

(52) U.S. Cl. 348/231.99

(57) ABSTRACT

Systems and techniques for image capture and management in a retail environment. One or more retail cameras are directed so as to capture digital images. Each camera is configured so as to provide image information that can be used in a retroactive focusing process. Captured images are retroactively focused to provide sharp images of objects of interest, and the objects of interest are used in appropriate retail applications, such as site security, transaction security, and inventory control.

### FIELD OF THE INVENTION

The present invention relates generally to improvements to imaging systems used in retail environments. More particularly, the invention relates to improved systems and techniques for capturing and processing of digital images in retail imaging systems, such as security and inventory control systems, in such a way that captured images can be retroactively focused, and focus of captured images can be recovered as needed for image processing and use.

### BACKGROUND OF THE INVENTION

Numerous opportunities exist in retail operations for improved efficiency through the use of image capture. Security systems may advantageously use captured images for presentation to an employee, such as a cashier monitoring a self checkout operation, or an employee at a remote security station. Alternatively or in addition, a security system may use image recognition to identify products. For example, image recognition may be performed in order to identify products presented for checkout, in order to compare product information recorded in a transaction against actual presented product information.

As another example, image capture and image recognition may be advantageously used in inventory control. A camera may be transported through a retail environment, and directed so that its field of view at various times encompasses various objects of interest, such as shelf labels bearing information relating to products placed on shelves, and the products themselves. This information may be processed in order to interpret information of interest, such as shelf label information and identities and numbers of products. Images may, alternatively or in addition, be presented to an employee responsible for reviewing the information. An example of such a system is described in Kwan, “Methods and Apparatus for Inventory and Price Information Management,” U.S. application Ser. No. 11/866/642, filed Oct. 3, 2007, assigned to the common assignee as the present invention and incorporated herein by reference in its entirety. Numerous other uses of image capture and processing may be contemplated.

In order to be useful, image information should be in acceptable focus. Traditionally, image focus has been accomplished by optical means, for example, using a small aperture to provide greater depth of field, or using a lens that is adjusted manually or automatically until objects of interest in an image are in focus. Efforts to provide an acceptable image sharpness have typically faced a variety of constraints. The use of a smaller aperture, for example, may require a stronger illumination in order to provide acceptable image brightness. Providing an adjustable lens adds cost and weight, and adjusting that lens takes time. For example, a security camera at a checkout station might monitor objects as they were being swept across a scanner and placed in a bag. This process, especially when conducted by a proficient customer or a skilled employee, takes only a short time, sometimes on the order of a second. A camera might not be able to achieve an optical focus during this time, so that it would be impossible to capture an image clear enough for comparison with recorded product information. Requiring a customer or employee to slow down the scanning process to accommodate the needs of a security camera impedes efficiency and leads to customer and employee dissatisfaction. Similarly, the use of adjustable optical elements in an inventory control system adds weight and cost, and spending time to focus such elements decreases efficiency.

### SUMMARY OF THE INVENTION

Among its several aspects, the present invention addresses such problems, as well as others, by providing for capture of a digital image in retail applications using techniques that allow for post capture processing of the image in order to provide a focused image. Such processing may be accomplished in order to focus elements of interest in the image, to achieve an image with a relatively great depth of field, or both. According to one aspect of the invention, a retail system includes a plurality of camera stations, each including a camera configured to capture images modulated to allow for refocusing. Camera stations may include a checkout security camera and a camera platform, such as an automated camera platform, surveying a retail location in order to perform inventory control. Each of the camera stations may include a camera configured to capture images that can be refocused. Captured images are provided to a data processing device, such as a computer incorporated into the camera station employing a particular camera, a central server, or any other data processing device to which it is desired to deliver images. Each image is refocused using appropriate techniques. As images are taken of objects within the field of view of the camera employed in each camera station, the images are processed to accomplish refocusing as required, and the refocused captured images are used as needed, for example, to furnish a sharp image to an employee station for review by an employee, or to perform image recognition on the refocused image for comparison against stored product information. Images can be captured as often as needed, without a need for optical focusing or the time required for optical focusing. An inventory control camera can similarly employ an appropriate camera to capture images as needed, without a need for optical focusing. The ability to provide for retroactive focusing in an inventory control camera station provides for a number of areas of increased efficiency, such as eliminating the need to take time for optical focusing, as well as simplifying the path taken by the camera. For example, rather than physically move the camera to bring objects into focus.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a retail location employing retroactive focusing for image capture according to an aspect of the present invention;

FIG. 2 illustrates a checkout station employing an extended depth of field security camera according to an aspect of the present invention;

FIG. 3 illustrates an inventory control camera platform according to an aspect of the present invention; and

FIG. 4 illustrates a process of image capture, processing and use according to an aspect of the present invention.

### DETAILED DESCRIPTION

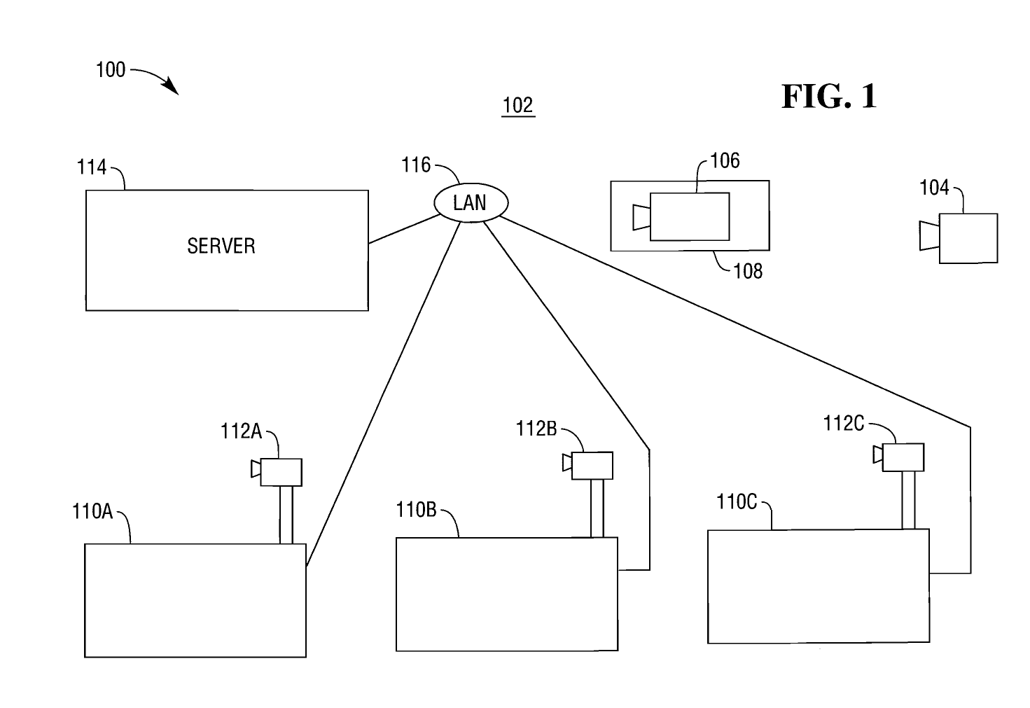

FIG. 1 illustrates a retail transaction processing and inventory control system 100 according to an aspect of the present invention. The system 100 is suitably deployed at a retail location 102, and provides for the capture, storage, and use of digital images as needed for various purposes. For example, image capture may be employed for transaction verification and site security. As another example, image capture may also be used for inventory control. Images captured and processed according to the techniques presented here may be used for any additional purpose desired, such as marketing, employee monitoring, or other purposes. The system 100 includes a location security camera 104, an inventory control camera 106 mounted on an automated platform 108, and a plurality of checkout stations 110A-110C, the checkout stations 110A-110C employing security cameras 112A-112C, respectively. The system. 100 also includes a server 114, maintaining information needed in retail operations, and receiving and using images captured by the various cameras 104, 106, and 112A-112C. The server 114 may suitably communicate with various data processing devices over a local area network 116, which may suitably be a wired network, a wireless network, or a network employing both wired and wireless communication links. Each of the cameras 104, 106, and 112A-112C is suitably configured to capture images allowing for retroactive focusing. Developing research on processing and manipulation of digital image data has produced various techniques for reshaping data captured on a digital image sensor. For example, techniques have been developed to cause the creation of spectral replicas of an image so that information on an entire 4D field entering a camera is captured on a 2D sensor, and can be recaptured by appropriate processing, and other techniques have been developed that allow the encoding of an image of a layered Lambertian scene so that chosen layers of the image can be refocused through appropriate computation, with all the layers being recombined, if desired. In each case, a mask, appropriately designed and placed in the camera, is used to modulate the light field entering the camera. The captured image can be processed mathematically to recover a focused image. Such encoding, image capture, and focus recovery is discussed by Ashok Veeraraghaven, Ramesh Raskar, Amit Agrawal, Ankit Mohan, and Jack Tumblin, in “Dappled Photography: Mask Enhancement Cameras for Heterodyned Light Fields and Coded Aperture Refocusing,” presented at ACM Siggraph 2007 and available, for example, at
http://www.umiacs.umd.edu/˜aagrawal/sig07Sig07CodedApertureOpticalHeterdyningLowRes. pdf, which is incorporated by reference herein in its entirety. The present invention adapts such techniques to retail imaging as addressed in additional detail below.

Depending on the design of each camera station, retroactive focusing may be performed by the camera itself by a computer employed in the camera station, or by the server 114. In the present exemplary embodiment, each of the cameras may suitably be a conventional digital camera employing a mask to create a modulated image, but without any other special electronics or data processing capability to demodulate the image to achieve retroactive focusing. Instead, retroactive focusing may be performed by a computer or other data processing system receiving the image from the camera, although if desired, appropriate electronics and programming may be included in the camera to allow for in camera retroactive focusing. Additional details of image capture, processing, and use are described in greater detail below.

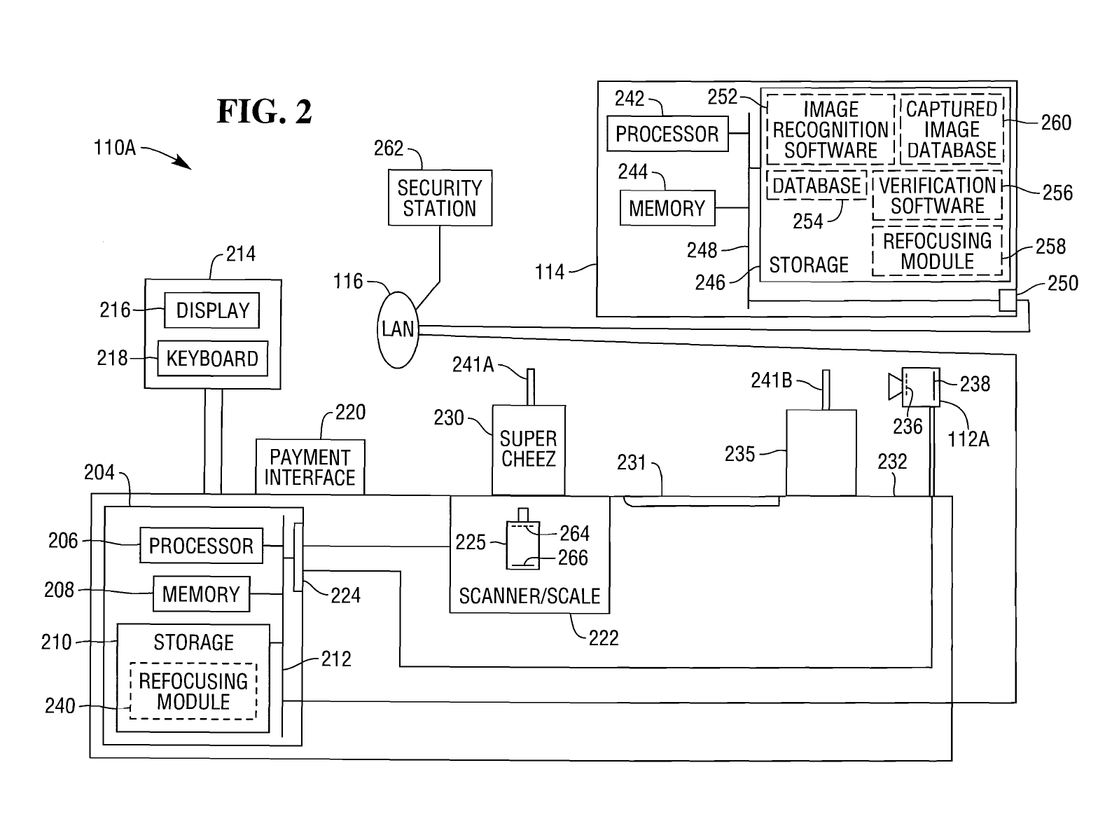

FIG. 2 illustrates additional details of the exemplary checkout station 110A. In order to avoid repetitious description, the stations 110B and 110C are not described in detail here, but may suitably be similar to the station 110A. The station 110A is suitably a self service checkout station, but the teachings of the present invention may be readily adapted to use with an employee operated checkout system, of for other types of inventory or transaction control. The station 110A includes a computer 204. The computer 204 may suitably include a processor 206, high speed memory 208, long term storage 210, all communicating over a bus 212. The station 110A may employ various data entry devices, such as a user interface 214, including a display screen 216, which may suitably be a touch screen, and keyboard 218. The user interface 214, as well as additional data entry devices, such as a payment interface 220 and scanner/scale combination 222, communicate with the computer 204 through one or more device interface connections, such as the device interface 224 The scanner/scale combination 222 may suitably be an imaging scanner/scale combination, including a digital camera 225. The interface 224 may suitably he a set of universal serial bus (USB) ports, a combination of USB ports and other types of ports, or any other suitable combination of communication connectors. The computer 204 may communicate with the central server 114 over the local area network 116.

A customer using the station 110A suitably passes an item, such as a box of crackers 230, over the scanner 222, or enters the item into the transaction in some other way, such as by using the keyboard 218. The customer then places the item into a post scan area, such as on a conveyer belt 231 or in a bagging area 232. The computer 204 uses the camera 112A to monitor an area in which security is desired. For example, the camera 112A may monitor the entire extent of the station 110A, the scan area, the post scan area, or may alternate between a combination of areas. For example, the camera may suitably be able to pan and tilt under the control of the computer 204. The camera 112A may also have optical or digital zoom capabilities, but for simplicity and low cost, the camera 112A may be a simple fixed focus camera, capable of capturing an image of a desired field of view, but focused on only a portion of that field of view. The camera 112A may suitably be focused at a suitable point in an area of interest, for example, the midpoint of the area between the payment interface 220 and the camera 112A. Objects outside of a limited portion of the field of view may not be in optical focus, but the camera suitably includes a mask 236 for modulating light rays entering the camera. The modulation imposed by the mask 236 allows for processing of the image or image captured by a sensor 238 to recover an image having an extended depth of field. The image may be processed by the computer 204, by a remote device such as the server 114, or by processing elements within the camera 112A itself if it is desired to equip the camera to perform such processing images are taken by the camera 112A as desired, by simply directing the camera 112A so as to encompass the field of view desired. When desired, an image is captured and stored. Capturing and storing of an image may be performed after specified events, such as scanning of a product, may be performed at specified intervals, may be performed so as to cycle through a series of views, or may be performed in some other desired way so as to provide security information. One advantageous technique for providing security is to perform image recognition on an image of an object, such as a product, within the field of view of the camera 112A, in order to compare the image against stored image information for a product of interest. Examples of a product of interest are a product that has been scanned, or a product that is subject to be illicitly substituted for an item that has been scanned, such as a high value item of approximately the same size and shape as a lower value item.

The camera 112A suitably takes images immediately upon command, periodically, or according to another predetermined procedure, without a need for optical focus. In a checkout environment, an object may not remain in the field of view of the camera 112A for more than a short time, and may not be in the field of view long enough for optical focusing to be accomplished. This may be true even if there is no attempt to defeat security features. Efficient checkout typically involves the rapid scanning of items one after another, often with each item being placed in a bag after it is scanned. Optical focus involves adjustment of optical elements, and automated optical focus requires sensing of parameters indicative of whether an object is in focus, and physical movement of optical elements until parameters are within desired ranges. Such procedures may not be able to be accomplished while an object in a checkout transaction is in a field of view of a camera such as the camera 112A.

Therefore, the camera 112A simply captures and stores images as desired, or relays images for storage and processing, without taking time for focusing. Instead, focus is accomplished on the captured image through suitable processing, making a retroactively focused image available for image recognition or other use. The camera 112A therefore includes the mask 236, as noted above. The mask 236 is suitably designed and placed such that the camera 112A will serve as an encoded blur camera as described by Veeraraghaven et al. referred to above. In this embodiment, the mask 236 is suitably a coarse, broadband mask placed at the aperture of the lens used by the camera 112A. The mask 236 provides the ability to refocus an image within the field of view of the camera by mathematical processing of the image information as modulated by the mask. The mask 236 imposes a frequency modulation function which is multiplied by the frequency transform of the light field entering the camera 112A. This is equivalent to a convolution of the mask and a sharp image of the scene in the field of view of the camera 112A. The scale of the mask 236 is dependent on the degree of defocus blur of the captured scene, and a sharp image can therefore be recovered by deconvolution of the blurred image with the scaled mask.

In order to recover a sharp image, the captured image is subjected to a refocusing procedure, here shown as accomplished by a refocusing module 240, shown as hosted by the storage 210 of the computer 204, although it will be recognized that such a refocusing module may be hosted on the server 114, the camera 112A itself, or on another desired device to which the captured images may be provided for processing.

In the case of encoded blur, accomplished using the mask 236 of the camera 112A as illustrated here, the refocusing module 240 analyzes the scene and estimates the number of layers and the point spread function (PSF) for each layer. For a number of layers n, a number of deblurred images n are then created by deconvolving the captured blurred images by the estimated blur levels. To refocus at a particular layer of interest, the remaining layers are reblurred and the layer of interest is composited with the remaining layers to obtain the refocused image.

Once the image has been captured, the layer of interest is identified, and refocused if blurred. Typically, any scene within the field of view of the camera 112A will include one or more objects of interest. These objects of interest will frequently be identifiable through size, by being within a prescribed distance from the field of view of the camera 112A, by proximity to a known shape, such as a distinctive pattern on a platform on which products are presented for scanning, or by other identifiable characteristics. For example, the markers 241A and 241B may be placed at known distances from the camera 112A and objects determined to be near the markers 241A and 241B may be given priority for refocusing, if out of optical focus.

Once an object of interest has been identified, the layer in which the object appears can be determined. Such determination can assist in refocusing, by eliminating any need to deblur layers beyond the layer or layers of interest.

Once refocused, an image can be used for security or other desired purposes. For example, the image may be passed to or stored on the server 114, for comparison to an image set for a product entered into a transaction, in order to determine if the product that was placed within the view of the camera 112A was the product identified in the transaction. Alternatively or in addition, the image may be compared with an image set for a product susceptible to being illicitly substituted for the entered product, such as a product of a similar size and shape, but having a higher value.

The server 114 suitably includes a processor 242, memory 244, and storage 246, communicating over a bus 248, as well as an external interface 250 providing a connection to the network 116. The server 114 suitably hosts image recognition software 252, a database 254, suitably storing image sets for image recognition and comparison, and other information. The server 114 also suitably stores verification software 256, for comparing recognized items against items presented for purchase or otherwise represented to be the items placed within the field of view of the camera 112A. The server 114 may also host a refocusing module 258, in case it is desired to deliver images to the server 114 for refocusing. The server 114 may also host a captured image database 260, allowing for storage of captured images, for example, for storing evidence of an attempted fraudulent transaction, or for statistical analysis, such as analysis to determine which items are likely to be the subjects of fraudulent substitutions. If desired, refocusing of images taken under appropriate circumstances may be deferred until any desired time. For example, processing of objects that are to be used in statistical analysis may be deferred, particularly if processing resources are at a premium.

Because the image as captured by the sensor 238 does not need to be in focus, images can be easily captured and more images can be taken, if desired, than is typically possible if time must be taken for optical focus before taking an image. More views can be taken, for example, with multiple cameras similar to the camera 112A, and these cameras can be placed where desired, whether or not they are well positioned for optical focus, so long as they can capture a recoverable image.

As an alternative or in addition to using the image or images for automated image comparison, the captured images may be provided to a security station such as the station 262. Automated refocusing may be accomplished or, if desired, an attendant at the security station may select an area of interest, for example, by marking an appropriate area, and this information may be used by the refocusing module 240 to assist in the processing for refocusing, for example, by identifying the objects falling in a particular layer.

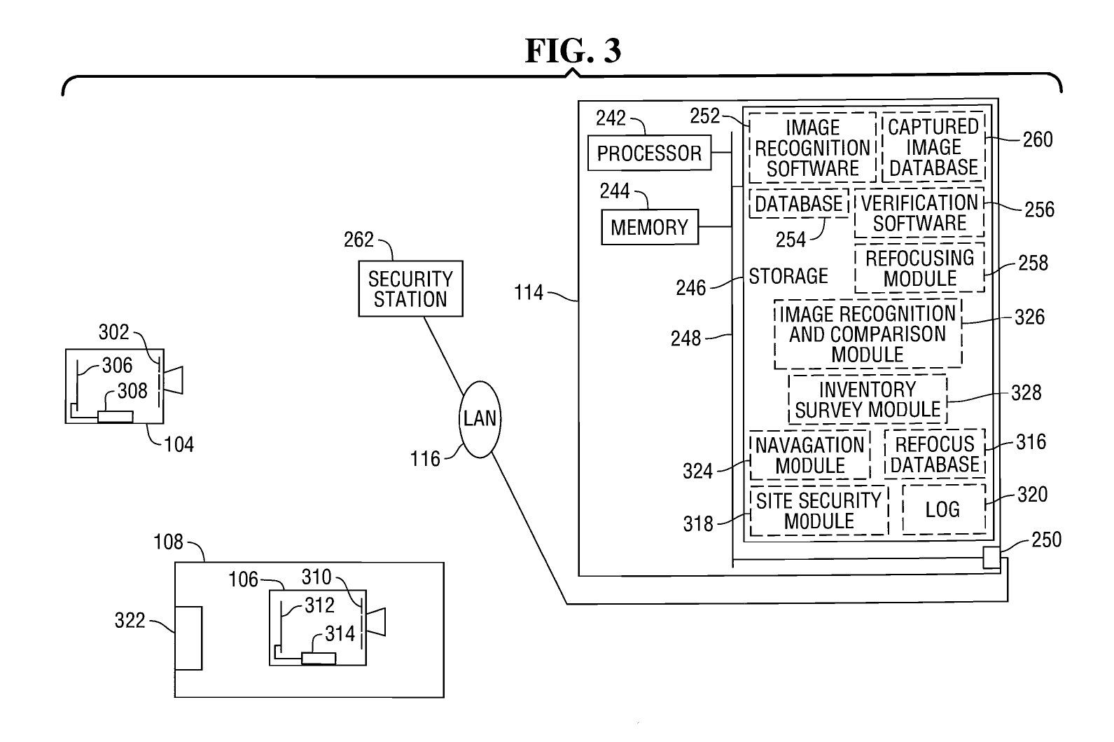

In addition to providing retroactive focusing capability for the security camera 112A, the camera 225 in the scanner/scale combination 222 can be provided with a mask 264, so as to modulate light falling on the sensor 266. Provided that sufficient processing power is available, and particularly as processing power continues to increase, retroactive focusing can be accomplished in imaging bar code scanning using the retroactive focusing techniques described above, allowing for a greater flexibility in positioning of bar codes to be scanned. Retroactive focusing can also be employed to provide focused images of other objects within the field of view of the camera 225, such as the object bearing the bar code to be scanned or another object FIG. 3 illustrates additional details of the camera platform. 108 and the camera 106, as well as the camera 104, of FIG. 1. FIG. 3 also illustrates the server 114 and the local area network 116. The cameras 104 and 106 suitably transmit images over the network 116 to the server 114. The camera 104 suitably includes a mask 302 and a sensor 306, as well as a control and interface package 308. The camera 106 suitably includes a mask 310, a sensor 312, and a control and interface package 314. The camera 104 may suitably receive commands from the server 114, which may include appropriate software to control the positioning and field of view of the camera 104, and to direct the capture of images by the camera 104. The server 114 includes the elements noted above, in particular, the refocusing module 258. The server 114 hosts a refocus database 316, storing parameters for each different camera type for which refocusing is to be performed by the server. The server 114 also hosts a site security module 318, which retrieves images from the camera 104 and similar site security cameras, submits them to the refocusing module 258, and manages the images as needed. For example, the site security module 318 may store images in a log 320, suitably indexed by time. Images may also be passed to a security station such as the security station 262, which may also allow an employee to control the camera 104. The security camera 104 may take images as desired, without a need for optical refocusing. In addition, the camera 104 may maintain a desired field of view, for example, a wide field of view, without a need to achieve optical focus on a particular object of interest. Instead, the object of interest may be retroactively focused by the refocusing module 258.

The camera platform 108 may also suitably include a navigation controller 322, receiving commands from a navigation module 324. The navigation module 324 employs images received from the camera 106, processed using an image recognition and comparison module 326, to direct the platform 108. The platform might, for example, be directed so as to take a comprehensive survey of shelf labels and contents, and might be directed with respect to specified reference points, with the position of the platform 108 being determined by visual recognition of a reference point with the navigation module 324 directing the platform 108 along a path to a subsequent reference point.

The server 114 also hosts an inventory survey module 328, receiving images from the camera 106 and using the images as needed, for example, performing image recognition and comparison to verify shelf label accuracy and identity and presence of products, and other relevant information. Additional details of inventory survey, such as may be accomplished by elements similar to the camera 106 and platform 108, are described in Kwan, cited above. The inventory survey module 328 passes images to the refocusing module 258 as needed. The ability of the refocusing module 258 to refocus images allows for a simplification of the actions taken by the platform 108 and the camera 106. For example, the camera 106 can be directed to take images at different fields of view and different distances without a need for optical refocusing. In addition, the platform 108 can be directed on a simpler routing than might be possible if the platform were required to achieve optical focus of objects of interest. For example, the platform might simply be directed along the center of an aisle, whether or not each object of interest could be brought into focus from a position along that path without refocusing as described herein, because the refocusing module 258 could refocus the objects. It will be recognized that while a moving platform 108 is discussed here, inventory survey can be performed in numerous ways, for example, using a camera carried by an employee or an arrangement of fixed cameras, using the techniques of the present invention. It will also be recognized that while inventory, including shelf labels and shelf contents, are addressed here as examples of items that are advantageously surveyed using the techniques of the present invention, a wide variety of information might be gathered using such techniques.

In addition or as an alternative to employing an encoded blur camera, that is, a camera with an appropriately configured broadband mask at the aperture, one or more of the cameras 104, 106, 112A-112C, or other cameras, maybe configured as a heterodyne light field camera. Such a camera includes an appropriately configured mask near the sensor of the camera. The mask casts a soft shadow on the sensor, producing spectral replicas of the 4D light field entering the camera, with the number and arrangement of the spectral replicas being determined by the frequency response of the mask. A traditional camera captures a 2D slice of a 4D light field, but the spectral replicas produced by the mask of a heterodyne light field camera allow reconstruction of the entire 4D light field. The 4D light field is reconstructed by taking the 2D fast fourier transform of the captured image, producing an arrangement of spectral copies. In the example given by Veeraraghaven et al. the mask is a cosine mask with four harmonics, or 4*2+1, or 9, harmonics in its frequency response, producing a 9*9 arrangement of spectral replicas. The 2D tiles are rearranged into 4D planes, and the inverse fast Fourier transform is computed to reconstruct the 4D light field.

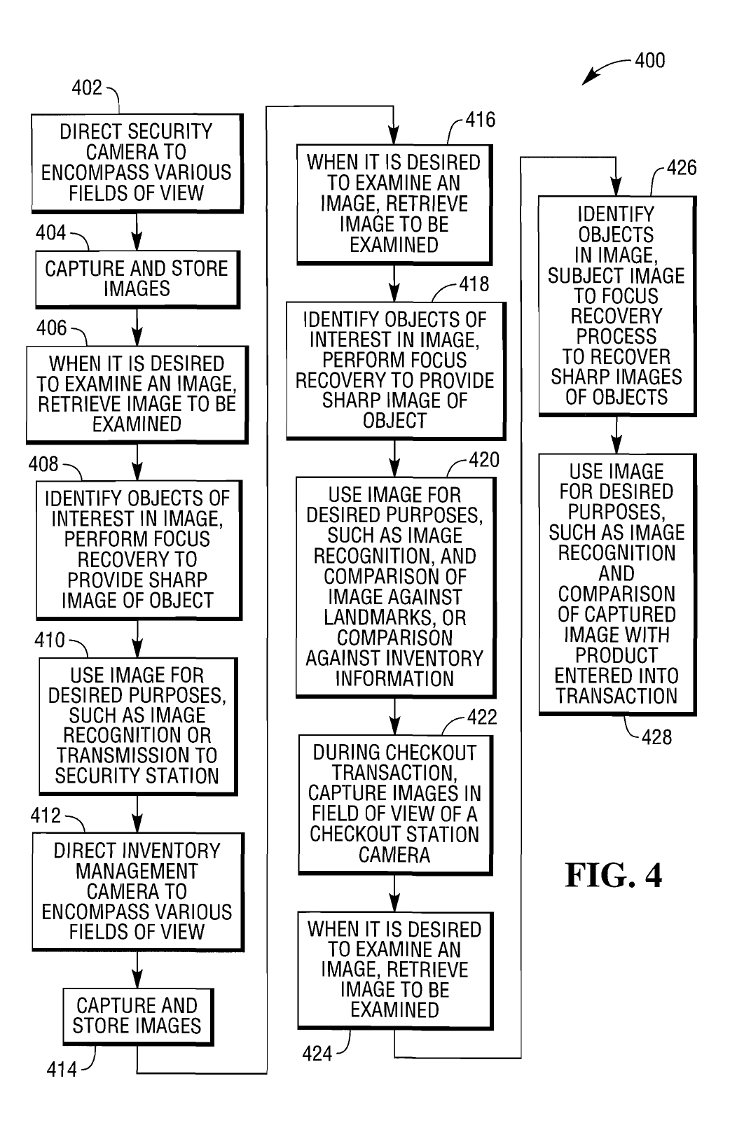

FIG. 4 illustrates a process 400 of security control and inventory management according to an aspect of the present invention, suitably carried out by a system similar to the system 100 and the elements thereof illustrated in FIGS. 1-3. All of the steps of the process do not need to be carried out in sequence, but various combinations and sequences of steps may be carried out as needed, and portions of the process may be implemented as desired. At step 402, a security camera is directed so as to encompass various fields of view. At step 404, images within the field of view of the camera are captured and stored. Images are captured without taking time for optical focusing, and may successively be taken of objects at different distances without optically focusing on the objects. At step 406, when it is desired to examine one or more images, an appropriate image is retrieved. At step 408, one or more objects of interest in the image are identified and the image is subjected to a focus recovery process to provide a sharp image of the objects of interest. The focus recovery process may suitably be a process of demodulating image information that was previously subjected to a modulation function imposed by a mask placed in the security camera. At step 410, the image is used for desired purposes, such as image recognition, transmission to a security station, storage, or other desired purposes.

At step 412, an inventory management camera is directed so as to encompass various fields of view, suitably by directing a platform carrying the camera along desired paths and directing the perspective of the camera as the platform travels. At step 414, images within the field of view of the camera are captured and stored. Images are captured without taking time for optical focusing, and may successively be taken of objects at different distances without optically focusing on the objects. At step 416, when it is desired to examine one or more images, an appropriate image is retrieved. If the image is to be used in navigation, for example, if the image was taken while the platform bearing the camera was being directed to determine its location or to seek a landmark indicating a waypoint, retrieval may be performed immediately after storage, or the image may be held for processing without being committed to any sort of long term storage. At step 418, one or more objects of interest in the image are identified and the image is subjected to a recovery focus process to provide a sharp image of the objects of interest. At step 420, the image is used for desired purposes, such as image recognition, followed by comparison of the image against stored security information, comparison of the image against landmarks used in navigation of the camera platform, or other desired uses, such as delivery of the image to an inventory review station.

At step 422, during a checkout transaction, images in the field of view of a transaction security camera are captured as appropriate, for example, at each transaction entry, at specified intervals of time, when an object of interest enters the field of view of the camera, or at other suitably intervals. The camera may suitably be directed so as to encompass various fields of view, for example, by panning and tilting the camera. At step 424, when it is desired to examine one or more images, an appropriate image is retrieved. At step 426, one or more objects of interest in the image are identified and the image is subjected to a focus recovery process to provide a sharp image of the objects of interest. Focus recovery may be conducted at any time during the transaction, whether the object whose image is being refocused is in the field of view of the camera or not. At step 428, the image is used for desired purposes, such as image recognition, followed by comparison of the image against stored security information to determine whether the product entered into the transaction is the same as the object actually in the field of view of the camera, transmission to a security station, or other desired purposes.

While the present invention is disclosed in the context of a presently preferred embodiment, it will be recognized that a wide variety of implementations may be employed by persons of ordinary skill in the art consistent with the above discussion and the claims which follow below.

I claim:

1. An image processing system for processing and managing images captured in a retail environment, comprising:
memory for storing images captured by a digital camera;
a processor for processing the images; and
program memory for storing instructions executable by the processor, for using information in the stored image to provide retroactive focusing of objects of interest in the image, the objects of interest being identified as objects to be compared against stored image information in a retail information storage system.

2. The system of claim 1, wherein the instructions further directing controlling the camera to capture images in rapid succession at one specific focus point, with captured images having objects of interest out of optical focus to be retroactively focused once the images are captured.

3. The system of claim 1, wherein the instructions further direct controlling the camera to move so as to encompass a variety of fields of view taking in objects at different distances, with captured images having objects of interest out of optical focus being retroactively focused once the images are captured.

4. The system of claim 11, wherein the instructions further direct retroactively focusing multiple objects appearing in a single captured image.

5. The system of claim 1, wherein the instructions further direct identifying objects of interest based on the context in which the objects appear in the image and concentrating retrofocusing on the objects of interest.

6. The system of claim 1, wherein the instructions further direct performing image recognition on product images captured during a checkout transaction and comparing the identification of products obtained from image recognition against stored product information associated with product information entered in the checkout transaction.

7. The system of claim 6, wherein retroactive focusing is performed on product images after a product whose images is captured has left the field of view of the camera.

8. The system of claim 3, wherein the instructions further direct controlling a platform carrying the camera to move along a path so as to cause the camera to encompass a variety of fields of view taking in objects at different distances.

9. The system of claim 8, wherein the instructions further direct refocusing multiple objects appearing in a single image so as to provide a sharp image of each of the multiple objects.

9. The system of claim 3, wherein the instructions further comprise performing image recognition on captured images of shelf labels appearing on store shelves and comparing the information provided by the image recognition against stored shelf label information.

10. The system of claim 3, wherein the instructions further comprise performing image recognition on images of shelf contents and comparing the information provided by the image recognition against stored inventory information.

11. The system of claim 4, wherein the captured images exhibit a modulation imposed by a mask and wherein retroactive focusing comprises demodulating the images to recover the focused image using information contributed by the mask.

12. The system of claim 9, wherein the mask is a broadband mask placed near the aperture of the digital camera.

13. A method of image management in a retail environment, comprising the steps of:
capturing one or more images a field of view encompassed by a digital camera;
for each image, identifying an object of interest in the image and performing retroactive focusing on the image so as to provide a sharp image of the object of interest; and
comparing one or more images of objects of interest against stored image information in a retail inventory system.

14. The method of claim 13, wherein capturing the one or more images includes capturing a plurality of images in rapid succession.

15. The method of claim 14, wherein performing retroactive focusing is performed at a time substantially after capture of the images, the time being selected being a period of lower demand for processing recources.

16. The method of claim 14, wherein capturing the one or more images includes capturing images of a transaction area so as to provide a relatively comprehensive succession of views of the transaction area during presentation of a product for entry into a transaction so as to detect substitution of objects during the presentation.

17. The method of claim 13, wherein capturing the one or more images includes directing the camera so as to encompass a variety of fields of view at objects at a variety of distances while maintaining a fixed optical focus at a specified distance.

18. The method of claim 16, wherein capturing the one or more images includes directing a platform carrying the camera along a path so as to cause the camera to encompass a variety of fields of view.

19. The method of claim 13, wherein the captured images exhibit a modulation imposed by a mask and wherein retroactive focusing comprises demodulating the images to recover the focused image using information contributed by the mask.

20. The method of claim 18, wherein the mask is a broadband mask placed near the aperture of the camera.
